(19) United States
(12) Patent Application Publication
(10) Pub. No.: US 2004/0195905 A1
(43) Pub. Date: Oct. 7, 2004

(54) Wheel and wheel insert combination

(76) Inventors: Fredrick Tracy French III, Chicago, IL (US); William Darl Keehler, Pontoon Beach, IL (US)

Correspondence Address: INVENTIONS UNLIMITED, 843 W. 14TH PLACE, CHICAGO, IL, 60608-2245, US

(21) Appl. No.: 10/827,126

(22) Filed: Apr. 19, 2004

Related U.S. Application Data
(63) Continuation-in-part of application No. 10/358,930, filed on Feb. 5, 2003.
(60) Provisional application No. 60/357,178, filed on Feb. 15, 2002.

(51) Int. Cl. B60B 7/04

(52) U.S. Cl. 301/37.28

(57) ABSTRACT

A method and apparatus for filling an aperture in a wheel disposed on a vehicle is disclosed herein. A wheel insert and a combination wheel and wheel insert are disclosed. The wheel insert fits into an aperture in the wheel with the edge surface engaging the aperture snugly and substantially filling the aperture. The wheel insert and a front surface of the wheel may be aligned horizontally where they are joined. At least one fastener may extend through apertures in the wheel insert and extend into orifices in the wheel to secure the wheel insert into the aperture. The method includes placing the wheel insert into the aperture and securing the wheel insert to the wheel.

### CROSS REFERENCE TO RELATED APPLICATION

This application is a continuation-in-part of U.S. Non-Provisional Application Ser. No. 10/358,930 filed on Feb. 5, 2003 which in turn claims the benefit of U.S. Provisional Application 60/357178, filed on Feb. 15, 2002 under 35 U.S.C. § 119(e), the subject matter of which are hereby incorporated herein by reference in their entirety.

### BACKGROUND OF THE INVENTION

1. Field of the Invention.

This invention relates in general to a method and apparatus for filling an aperture in a wheel disposed on a vehicle and more particularly to a combination wheel and wheel insert.

2. Description of Related Art.

To provide decoration and enhance a consumer's love of the automobile, modern wheels are trending toward the appearance of wagon wheels from the turn of the century. Recent wheel designs disclose an assembly upon which a tire is mounted, and an assembly which connects the wheel to an axle. The tire mounting section and the axle mounting section are connected by radially projecting spokes or connecting surfaces having large open areas which leave the brake assembly exposed.

Exposure of the brake assembly causes damage to occur to the brake disk, brake caliper and brake hydraulic lines. The damage results from dirt, road salt, gravel, road debris and other material entering through the open spaces in the wheel and coming into contact with the brake parts and assembly. Damage to the brake parts and the brake assembly result in extensive repair service and replacement of the damaged brake parts.

Decorative wheels having large spaces in the wheel assembly are also used in high performance vehicles. The high performance vehicles are often used in racing. Road debris entering the wheel assembly and the entering the brake assembly area may damage the brake assembly with catastrophic results.

Beyond the safety issue, wheels having large spaces in the wheel assembly provide numerous surfaces that interrupt air flow around the wheel and set up vortices that interact with the streamlined air flow of an automobile driving at high speed. Racing drivers seek to reduce air resistance and drag to glean every bit of speed possible from their vehicles. Interaction of air with the spoke surfaces and other protruding edges of the wheels is a major source of drag.

It can be seen that there is a need for a method and apparatus to overcome the disadvantages of the prior art.

### SUMMARY OF THE INVENTION

To overcome the limitations in the prior art described above, and to overcome other limitations that will become apparent upon reading and understanding the present specification, the present invention discloses a method and apparatus for protecting a brake assembly resident behind a wheel.

The present invention solves the above-described problems by insertion of wheel inserts into apertures in the wheel.

A method in accordance with the present invention is a method for filling an aperture in a wheel. The wheel has a tire engaging portion, an axle engaging portion having a plurality of lug receiving openings, and a connecting portion extending between the tire engaging portion and the axle engaging portion. The connecting portion has a front side and a rear side and a plurality of apertures extending from the front side through to the rear side and at least one wheel inserts insertable into at least one of the plurality of apertures in the connecting portion of the wheel, each wheel insert comprising a front insert side and a rear insert side. The method comprises securing a wheel insert into an aperture in the connecting portion of the wheel.

Another aspect of the present invention is that securing the wheel insert into the connecting portion aperture further comprises inserting the wheel insert into the aperture from the rear side of the connecting portion.

Another aspect of the present invention is that securing the wheel insert into the aperture further comprises inserting the wheel insert into the aperture from the front side of the connecting portion of the wheel.

Another aspect of the present invention is that securing the wheel insert into the aperture further comprises securing a plurality wheel inserts into a plurality of apertures into the connecting portion of the wheel.

Another aspect of the present invention is that securing the wheel insert into the aperture further comprises securing a plurality wheel inserts into a plurality of apertures into connecting portions of a plurality of wheels.

An apparatus in accordance with the present invention is a combination wheel and wheel insert comprising a wheel having tire engaging portion, an axle engaging portion having a plurality of lug receiving openings, and a connecting portion extending between the tire engaging portion and the axle engaging portion. The connecting portion has a front side and a rear side. The connecting portion has a plurality of apertures extending from the front side through to the rear and a plurality of wheel inserts insertable into the plurality of apertures in the connecting portion of the wheel. Each wheel insert is adapted to substantially fill the apertures in the wheel.

Another aspect of the present invention is that a side of the wheel insert exposed to view along a front surface of the wheel has design indicia thereon.

Another apparatus in accordance with the present invention is a wheel insert for insertion into an aperture in a wheel comprising a front side and a rear side. The wheel insert fits into and substantially fills the aperture in the wheel.

Another aspect of the present invention is that a side exposed to view along a front surface of the wheel has design indicia thereon.

Another aspect of the present invention is that the wheel insert is fabricated from a same material as the wheel.

Another aspect of the present invention is that the wheel insert is fabricated from a different material than the wheel.

Another aspect of the present invention is that the wheel insert is fabricated from a transparent material.

Another aspect of the present invention is that the wheel insert is fabricated from an opaque colored plastic material.

Another aspect of the present invention is that the wheel insert is fabricated from a base metal and is covered with another material.

Another aspect of the present invention is that the wheel insert is fabricated from one of a metal, an alloy of metals, and a composite material.

Another aspect of the present invention is that the wheel insert further comprises a fastening mechanism for securing the wheel insert to the wheel.

Another aspect of the present invention is that the wheel insert further comprises at least one edge adapted to cooperatively mate with an interior edge of the aperture in the wheel.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a side view of a prior art wheel showing the exposed brake disk visible through apertures in the connecting portion of the wheel;

FIG. 2 illustrates a side view combination wheel and wheel insert of an embodiment of the present invention;

FIG. 3 illustrates an edge on view of a wheel insert having a convex edge surface of an embodiment of the present invention;

FIG. 4 illustrates a front side view of a wheel insert having a convex edge surface of an embodiment of the present invention;

FIG. 5 illustrates a side edge view of a wheel insert having a convex edge surface of an embodiment of the present invention;

FIG. 6 illustrates an edge on view of a wheel insert having a concave edge surface of an embodiment of the present invention;

FIG. 7 illustrates a front side view of a wheel insert having a concave edge surface of an embodiment of the present invention;

FIG. 8 illustrates a side edge view of a wheel insert having a concave edge surface of an embodiment of the present invention;

FIG. 9 illustrates a rear side view of a wheel insert having a convex edge surface wherein the front side viewable when installed on a wheel of an embodiment of the present invention;

FIG. 10 illustrates a rear side view of a wheel insert having a concave edge surface wherein the front side viewable when installed on a wheel of an embodiment of the present invention;

FIG. 11 illustrates a rear side view of a wheel insert having a convex edge surface wherein the rear side viewable when installed on a wheel of an embodiment of the present invention;

FIG. 12 illustrates a rear side view of a wheel insert having a concave edge surface wherein the rear side viewable when installed on a wheel of an embodiment of the present invention;

FIG. 13 illustrates an isometric view of a wheel insert having a concave edge surface of an embodiment of the present invention;

FIG. 14 illustrates an isometric view of a wheel insert having a convex edge surface of an embodiment of the present invention;

FIG. 15 illustrates the connecting portion aperture of a wheel having a convex connecting portion aperture edge surface of an embodiment of the present invention;

FIG. 16 illustrates the connecting portion aperture of a wheel having a concave connecting portion aperture edge surface of an embodiment of the present invention;

FIG. 17 illustrates a Phillips head countersinking screw fastener to connect the wheel insert into a wheel of an embodiment of the present invention;

FIG. 18 illustrates a spring loaded twist latch fastener to connect the wheel insert into a wheel of an embodiment of the present invention;

FIG. 19 illustrates a hexagonal head countersinking screw fastener to connect the wheel insert into a wheel of an embodiment of the present invention;

FIG. 20 illustrates a schematic view demonstrating fastening the wheel insert into a wheel using a countersinking screw of an embodiment of the present invention;

FIG. 21 illustrates a schematic view demonstrating fastening the wheel insert into a wheel using the spring loaded twist latch of an embodiment of the present invention; and

FIG. 22 is a flowchart demonstrating a method of protecting a brake assembly of an embodiment of the present invention.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

The present invention provides a method and apparatus for protecting a brake assembly resident behind a wheel disposed on a vehicle and reducing aerodynamic drag produced by a rotating wheel, and more particularly to a combination wheel and wheel insert constructed to cover and protect the brake assembly resident behind the wheel and reduce aerodynamic drag produced by the rotating wheel.

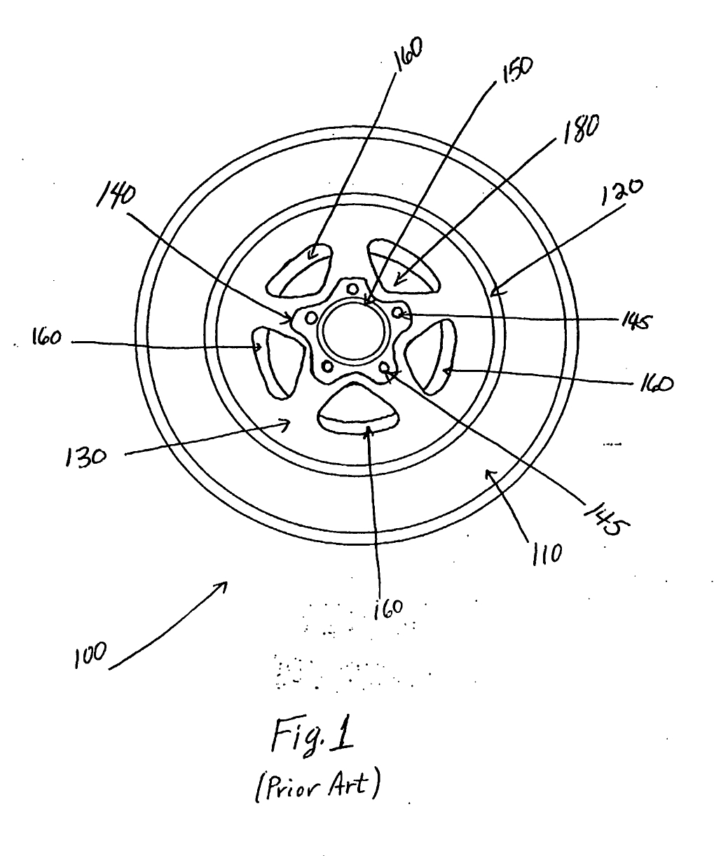

FIG. 1 illustrates a prior art wheel mounted on a vehicle 100. In FIG. 1, a prior art wheel 100 is shown having a tire 110 mounted onto a tire mounting portion 120. The tire mounting portion 120 is connected to a wheel engaging portion 150 by connecting portion 130. The connecting portion 130 of the wheel 100 is provided with a plurality of connecting portion apertures 160 through which the brake disk 180 is visible. The brake disk 180 and other brake parts of the brake assembly (not shown) are vulnerable to damage from intrusion of debris through the connecting portion apertures 160.

The wheel engaging portion 150 slides over an axle hub (not shown). The wheel 100 is connected to the axle (not shown) with a lug assembly 140 having a plurality of lug receiving openings 145 therein for receiving lugs (not shown) mounted on the axle.

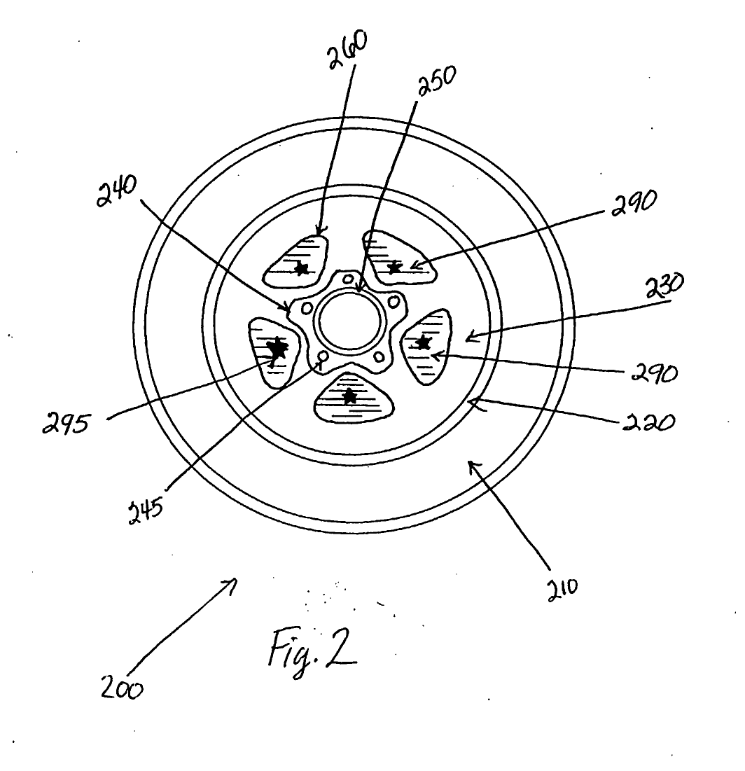

FIG. 2 illustrates a wheel and wheel insert combination for carrying out the method of the present invention 200. In FIG. 2, a wheel 200 is shown having a tire 210 mounted onto a tire mounting portion 220. The tire mounting portion 220 is connected to a wheel engaging portion 250 by connecting portion 230. The connecting portion 230 of the wheel 200 is provided with a plurality of connecting portion apertures 260 wherein wheel inserts 290 of an embodiment of the present invention are shown fitted into the connecting portion apertures 260. The wheel inserts 290 and the connecting portion apertures 260 of the wheel 200 are designed to reciprocatingly fit together such that the entire connecting portion aperture is filled with the wheel insert 290.

The wheel inserts 290 and the connecting portion apertures 260 of the wheel 200 are shown in FIG. 2, being generally triangular shaped, however the wheel inserts 290 and the connecting portion apertures 260 in which the wheel insert 290 fits may be round, square, oval, polyhedral or any other shape provided that the limitation, that the wheel insert 290 reciprocatingly fits and entirely fills the connecting portion aperture 260. The wheel insert 290 may be fabricated of the same material as wheel 200, or alternatively may be fabricated of a different material. The wheel inserts 290 may be fabricated of metal, composite alloys, transparent plastic, colored plastic and natural or synthetic materials. Transparent plastic wheel inserts may be embedded with glitter or other reflective particulate matter to enhance the aesthetic qualities of the wheel inserts and attract the attention of viewers and bystanders.

Design indicia 295 is shown on the wheel insert 290. The design indicia 295 shown is a star in FIG. 2, however the design indicia is not limited to the design shown, but may include indicia that shows the brand name of the tires, the wheels, the vehicle that the wheel is mounted on, or other decorative indicia for aesthetic or advertising purposes.

The wheel engaging portion 250 slides over an axle hub (not shown). The wheel 200 is connected to the axle (not shown) with a lug assembly 240 having a plurality of lug receiving openings 245 therein for receiving lugs (not shown) mounted on the axle. The brake disk and brake assembly are no longer visible upon implementation of the present invention as shown generally in FIG. 2. The brake assembly is now covered and protected from intrusion of debris.

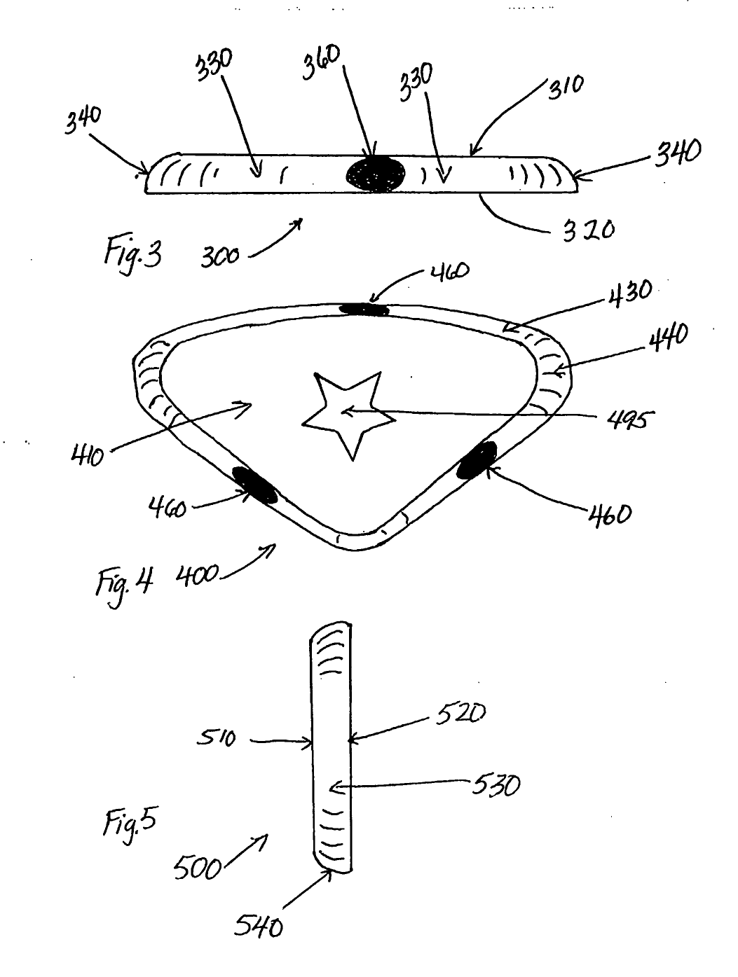

FIG. 3 illustrates a wheel insert 300 of an embodiment of the present invention. In FIG. 3, the wheel insert 300 is shown edge on. The wheel insert 300 has a top side 310, a bottom side 320, and an edge 330 having a convex edge surface 340. Also shown is a wheel insert aperture 360 for fastening the wheel insert 300 to the connecting portion aperture of the wheel. Although the edge surface 340 has been disclosed here as being convex shaped, the edge surface may be concave shaped, triangular shaped, shaped having a plurality of teeth or may be flat and smooth.

FIG. 4 illustrates a wheel insert 400 of an embodiment of the present invention. In FIG. 4, the wheel insert 400 is viewed looking at a front side 410. The front side 410 has design indicia 495 displayed thereon. The wheel insert 400 shows edge 430 having a convex edge surface 440 and a plurality of wheel insert apertures 460 for fastening the wheel insert 400 to the connecting portion aperture of the wheel. Although the wheel insert apertures are disclosed generally centrally located along the length of the edge of the wheel insert 400, the wheel insert apertures may be located at corners of the wheel insert or anywhere else along the edge of the wheel insert.

FIG. 5 illustrates a wheel insert 500 of an embodiment of the present invention. In FIG. 5, the wheel insert 500 is viewed from the side looking at an edge 530 having an edge surface 540. The front side 510 is horizontal to the rear side 520. Note that no wheel insert apertures are disclosed in the wheel insert 500 in FIG. 5. In an alternate embodiment, rather than being fastened to the wheel with fasteners, the wheel insert may be welded into place.

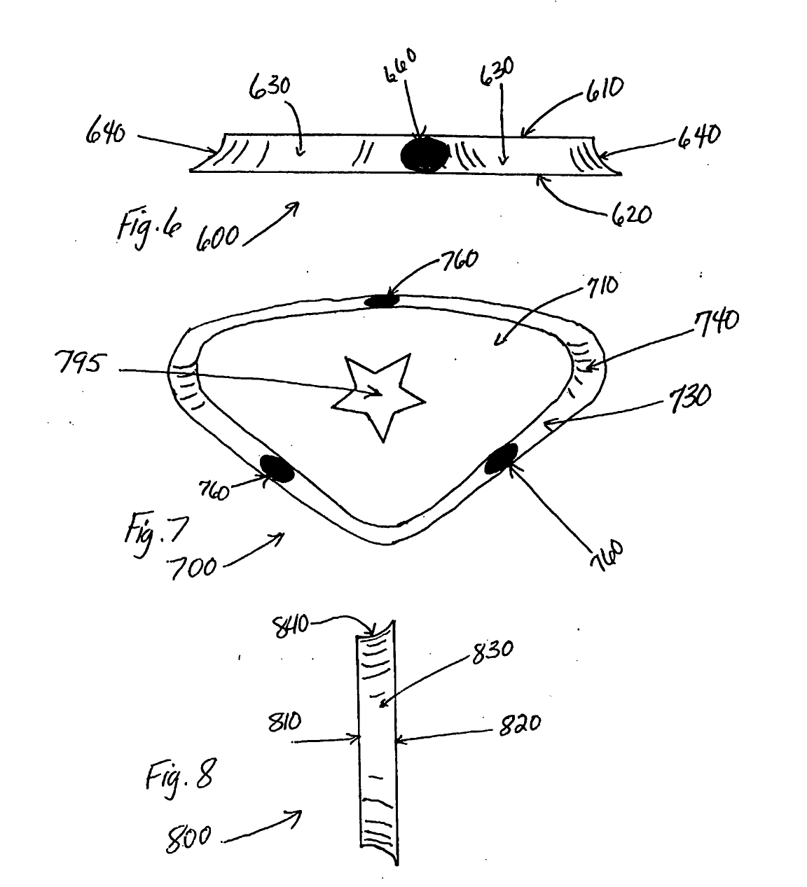

FIG. 6 illustrates a wheel insert 600 of an embodiment of the present invention. In FIG. 6, the wheel insert 600 is shown edge on. The wheel insert 600 has a top side 610, a bottom side 620, and an edge 630 having a concave edge surface 640. Also shown is a wheel insert aperture 660 for fastening the wheel insert 600 to the connecting portion aperture of the wheel. Although the edge surface 640 has been disclosed here as being concave shaped, the edge surface may be convex shaped, triangular shaped, shaped having a plurality of teeth or may be flat and smooth.

FIG. 7 illustrates a wheel insert 700 of an embodiment of the present invention. In FIG. 7, the wheel insert 700 is viewed looking at a front side 710. The front side 710 has design indicia 795 displayed thereon. The wheel insert 700 shows edge 730 having a concave edge surface 740 and a plurality of wheel insert apertures 760 for fastening the wheel insert 700 to the connecting portion aperture of the wheel. Although the wheel insert apertures are disclosed generally centrally located along the length of the edge of the wheel insert 700, the wheel insert apertures may be located at corners of the wheel insert or anywhere else along the edge of the wheel insert.

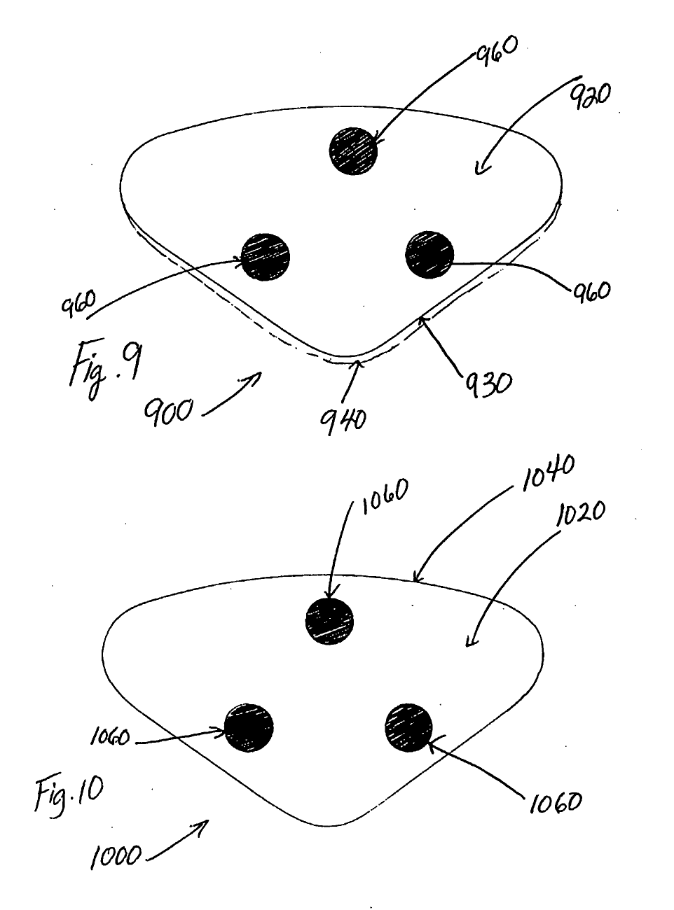

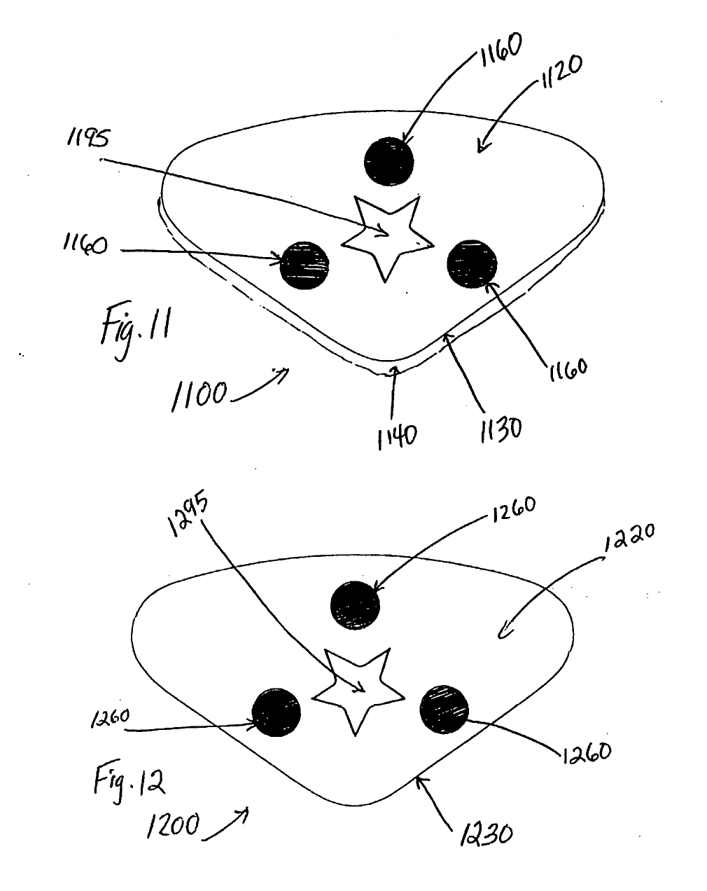

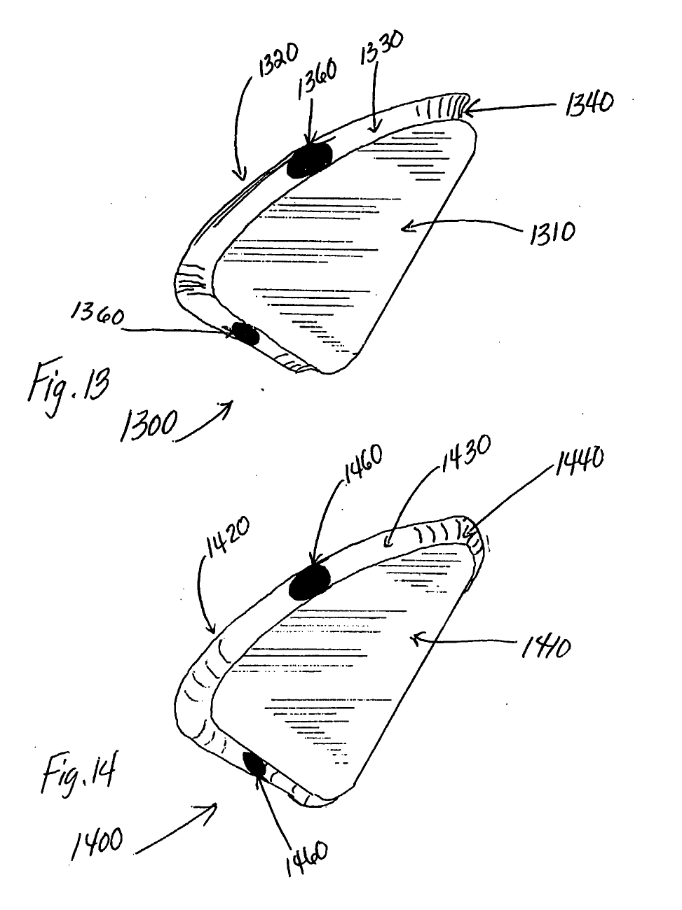

FIG. 8 illustrates a wheel insert 800 of an embodiment of the present invention. In FIG. 8, the wheel insert 800 is viewed from the side looking at an edge 830 having an edge surface 840. The front side 810 is horizontal to the rear side 820. Note that no wheel insert apertures are disclosed in the wheel insert 800 in FIG. 8. In an alternate embodiment, rather than being fastened to the wheel with fasteners, the wheel insert may be welded into place.

FIG. 9 illustrates a wheel insert 900 of an embodiment of the present invention. In FIG. 9, the wheel insert 900 is viewed from the rear side 920. The wheel insert 900, having an edge 930, having a convex edge surface 940, and a plurality of wheel insert apertures 960 for fastening the wheel insert 900 to the connecting portion aperture of the wheel. The embodiment disclosed in FIG. 9 is shown wherein the front side will be visible through the connecting portion aperture of the wheel by a viewer observing the wheel and wheel insert combination mounted on a vehicle. Although the edge surface 940 has been disclosed here as being convex shaped, the edge surface may be concave shaped, triangular shaped, shaped having a plurality of teeth or may be flat and smooth.

FIG. 10 illustrates a wheel insert 1000 of an embodiment of the present invention. In FIG. 10, the wheel insert 1000 is viewed from the rear side 1020. The wheel insert 1000, having an edge 1030, having a concave edge surface 1040, and a plurality of wheel insert apertures 1060 for fastening the wheel insert 1000 to the connecting portion aperture of the wheel. The embodiment disclosed in FIG. 10 is shown wherein the front side will be visible through the connecting portion aperture of the wheel by a viewer observing the wheel and wheel insert combination mounted on a vehicle. Although the edge surface 1040 has been disclosed here as being concave shaped, the edge surface may be convex shaped, triangular shaped, shaped having a plurality of teeth or may be flat and smooth.

FIG. 11 illustrates a wheel insert 1100 of an embodiment of the present invention. In FIG. 11, the wheel insert 1100 is viewed from the rear side 1120. The wheel insert 1100, having an edge 1130, having a convex edge surface 1140, and a plurality of wheel insert apertures 1160 for fastening the wheel insert 1100 to the connecting portion aperture of the wheel. The embodiment disclosed in FIG. 11 is shown wherein the rear side will be visible through the connecting portion aperture of the wheel by a viewer observing the wheel and wheel insert combination mounted on a vehicle. The rear side 1120 of the wheel insert 1100 is provided with design indicia 1195. Although the edge surface 1240 has been disclosed here as being convex shaped, the edge surface may be concave shaped, triangular shaped, shaped having a plurality of teeth or may be flat and smooth.

FIG. 12 illustrates a wheel insert 1200 of an embodiment of the present invention. In FIG. 12, the wheel insert 1200 is viewed from the rear side 1220. The wheel insert 1200, having an edge 1230, having a concave edge surface 1240, and a plurality of wheel insert apertures 1260 for fastening the wheel insert 1200 to the connecting portion aperture of the wheel. The embodiment disclosed in FIG. 12 is shown wherein the rear side will be visible through the connecting portion aperture of the wheel by a viewer observing the wheel and wheel insert combination mounted on a vehicle. The rear side 1220 of the wheel insert 1200 is provided with design indicia 1295.

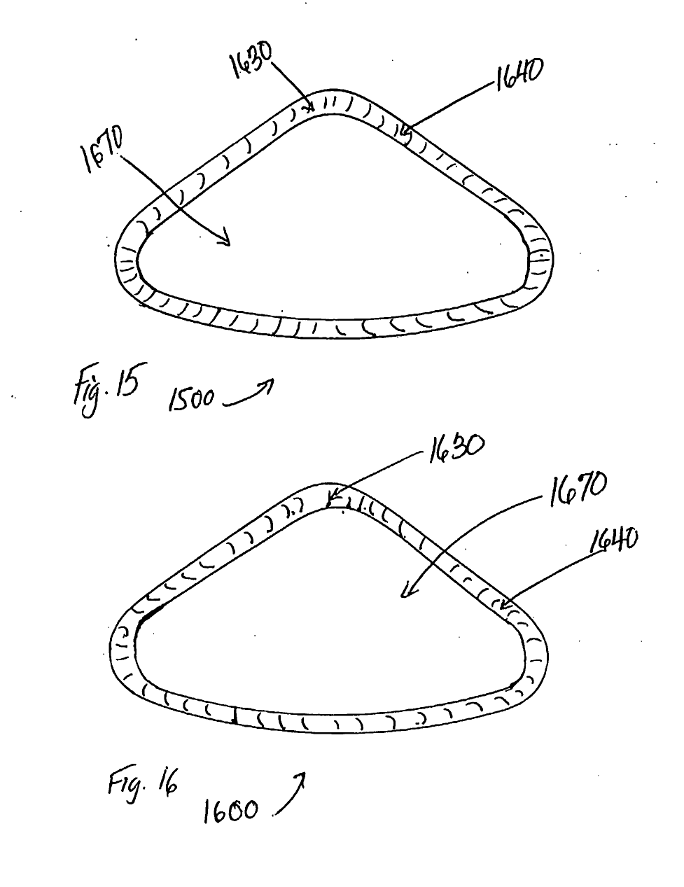

FIG. 13 illustrates an isometric view of a wheel insert of an embodiment of the present invention 1300. In FIG. 13, the wheel insert 1300 is shown having a front side 1310, a rear side 1320, and an edge 1330, having a concave edge surface 1340. Also shown are a plurality of wheel insert apertures 1360 disposed in the edge 1330.

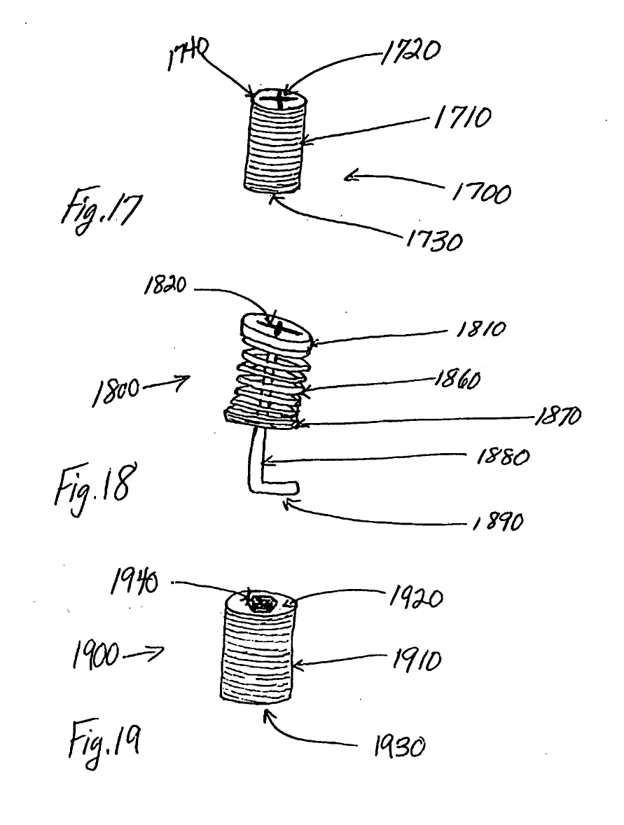

FIG. 14 illustrates an isometric view of a wheel insert of an embodiment of the present invention 1400. In FIG. 14, the wheel insert 1400 is shown having a front side 1410, a rear side 1420, and an edge 1430, having a concave edge surface 1440. Also shown are a plurality of wheel insert apertures 1460 disposed in the edge 1430.

Regarding FIGS. 3-14, the wheel insert apertures (360-1460, respectively) originate from the rear sides (320-1420, respectively) of the wheel inserts (300-1400, respectively) and extend through the edges (330-1430, respectively). In this manner the means for connection of the wheel inserts (300-1400, respectively) to the connecting portion apertures of the wheel may be hidden from view, if desired. In FIGS. 11 and 12, the means for connection are decoratively displayed (fasteners not shown).

FIG. 15 illustrates a connecting portion aperture of a wheel of an embodiment of the present invention 1500. In FIG. 15, the connecting portion aperture 1570, is shown. The connecting portion aperture 1570 has a connecting portion aperture edge 1530, having a concave connecting portion aperture edge surface 1540. The connecting portion aperture 1570 is adapted to reciprocatingly receive a wheel insert (300-500, 900 and 1100), having a convex wheel insert edge surface (340-540, 940 and 1140), wherein the wheel insert (300-500, 900 and 1100) entirely fills the connecting portion aperture 1570. Although the connecting portion aperture edge surface 1540 has been disclosed here as being concave shaped, the edge surface may be convex shaped, triangular shaped, shaped having a plurality of teeth or may be flat and smooth, with the provision that the connecting portion aperture edge surface must reciprocatingly fit with the corresponding wheel insert edge surface.

FIG. 16 illustrates a connecting portion aperture of a wheel of an embodiment of the present invention 1600. In FIG. 16, the connecting portion aperture 1670, is shown. The connecting portion aperture 1670 has a connecting portion aperture edge 1630, having a convex connecting portion aperture edge surface 1640. The connecting portion aperture 1670 is adapted to reciprocatingly receive a wheel insert (600-800, 1000 and 1200), having a concave wheel insert edge surface (640-840,1040 and 1240), wherein the wheel insert (600-800,1000 and 1200) entirely fills the connecting portion aperture 1670. Although the connecting portion aperture edge surface 1640 has been disclosed here as being convex shaped, the edge surface may be concave shaped, triangular shaped, shaped having a plurality of teeth or may be flat and smooth, with the provision that the connecting portion aperture edge surface must reciprocatingly fit with the corresponding wheel insert edge surface.

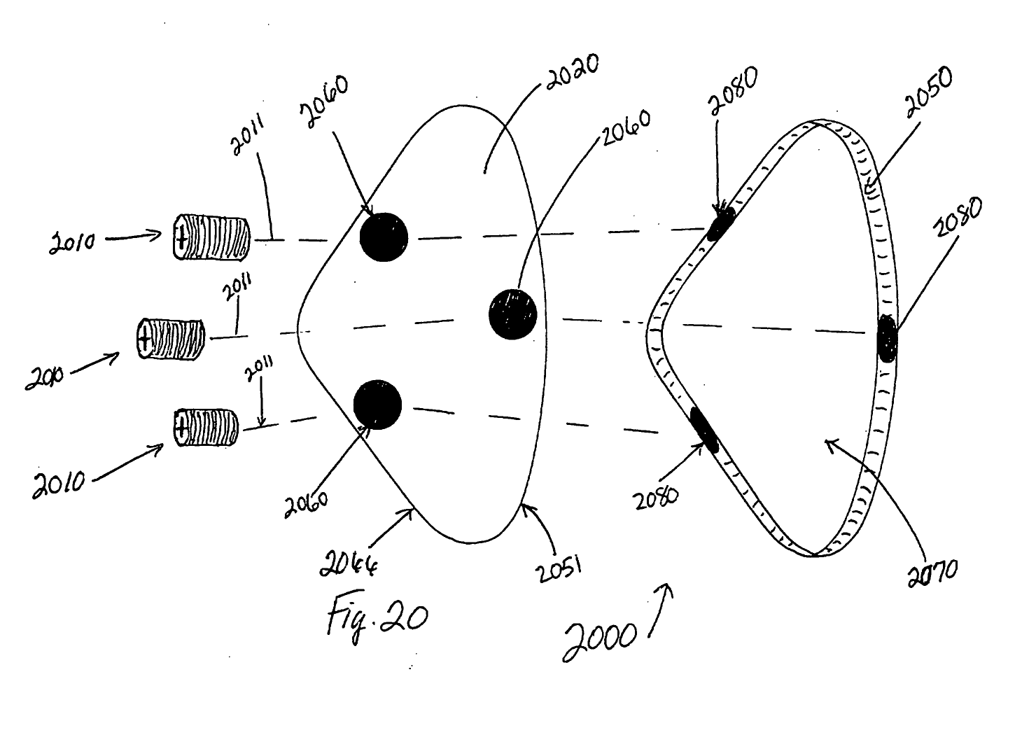

FIG. 17 illustrates a fastener of an embodiment of the present invention 1700. In FIG. 17, the fastener 1700 is a countersinking screw. The fastener 1700 has a head 1720 provided with a Phillips type screwdriver orifice. The fastener 1700 is provided with threads 1710 from the top 1720 to the bottom 1730, wherein the fastener will be completely received within the wheel insert aperture leaving no portion of the fastener exposed to view extending above a surface of the wheel insert. The fastener 1700 is inserted into the wheel insert aperture disposed on a rear side of the wheel insert and extending through the wheel insert and into a reciprocating orifice 2080 in the connecting portion aperture edge shown in FIG. 20.

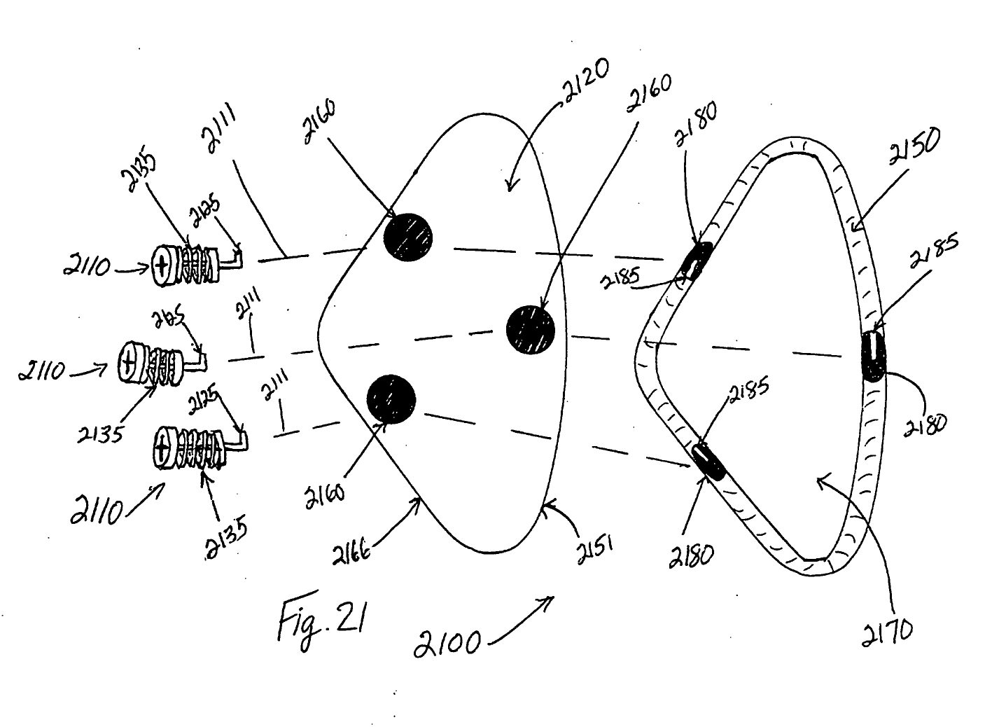

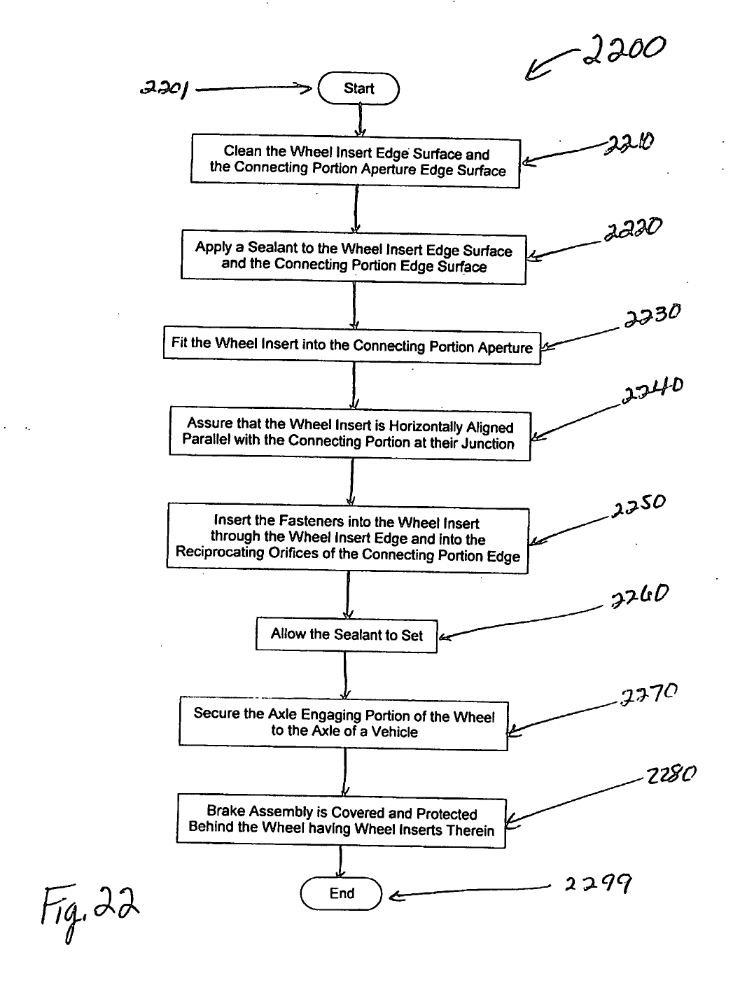

FIG. 18 illustrates a fastener 1800 of an embodiment of the present invention. In FIG. 18, a spring loaded twist latch fastener 1800 is disclosed. The fastener 1800 is provided with a head 1810, the head having a Phillips type screwdriver orifice therein. However, a regular screwdriver orifice, a hexagonal Allen wrench orifice, or any other type of turning orifice may be applied. The head 1810 is provided with a rod 1880 having a detent 1890 at an end thereof. Between the head 1810 and the detent 1890 a base portion 1870 is mounted to the rod 1880. A spring 1860 is disposed between the base 1870 and the head 1810 of the fastener 1800 wherein when an application the fastener 1800 secures the wheel insert to the connecting portion of the wheel, as described more fully in FIG. 21.

FIG. 19 illustrates a fastener of an embodiment of the present invention 1900. In FIG. 19, the fastener 1900 is a countersinking screw. The fastener 1900 has a head 1920 provided with a hexagonal type Allen wrench receiving orifice. The fastener 1900 is provided with threads 1910 from the top 1920 to the bottom 1930, wherein the fastener will be completely received within the wheel insert aperture leaving no portion of the fastener exposed to view extending above a surface of the wheel insert. The fastener 1900 is inserted into the wheel insert aperture disposed on a rear side of the wheel insert and extending through the wheel insert and into a reciprocating orifice 2080 in the connecting portion aperture edge. The Phillips type fastener 2010 as shown in FIG. 20, may be replaced with fasteners 1900 as described in FIG. 19. Although certain fasteners have been disclosed herein for connecting a wheel insert into a connecting portion aperture, other fastener may be used.

FIG. 20 illustrates a schematic view demonstrating fastening the wheel insert into a connecting portion wheel aperture of an embodiment of the present invention 2000. In FIG. 20, broken lines 2011 show the path wherein the fasteners 2010 connect the wheel insert 2066 into the connecting portion aperture 2070 of the wheel. The wheel insert 2066, when inserted into the connecting portion aperture 2070 is adapted such that the wheel insert edge 2051 reciprocatingly fits with the connecting portion edge 2050. The wheel insert edge 2051 may be convex and the corresponding connecting portion edge 2050 would then be concave or the wheel insert edge 2051 may be concave and the corresponding connecting portion edge 2050 would then be convex.

The wheel insert 2066 may be inserted into a front side of the connecting portion of the wheel wherein the rear side of the wheel insert is exposed to view when the wheel is mounted on a vehicle or the wheel insert 2066 may be inserted into a rear side of the connecting portion of the wheel wherein the front side of the wheel insert 2066 is exposed to view when the wheel is mounted on a vehicle. Design indicia is displayed on the side exposed to view.

The fasteners 2010 are inserted into the rear side 2020 of the wheel insert 2066 and extend through the edge of the wheel insert 2066 and extend into reciprocating orifices 2080 in the curved edge 2050 of the connecting portion aperture 2070. The fasteners are tightened until the head portions of the fastener no longer extend beyond the rear surface 2020 of the wheel insert 2066.

FIG. 21 illustrates a schematic view demonstrating fastening the wheel insert into a connecting portion wheel aperture of an embodiment of the present invention 2100. In FIG. 21, broken lines 2111 show the path wherein the fasteners 2110 connect the wheel insert 2166 into the connecting portion aperture 2170 of the wheel. The wheel insert 2166, when inserted into the connecting portion aperture 2170 is adapted such that the wheel insert edge 2151 reciprocatingly fits with the connecting portion edge 2150. The wheel insert edge 2151 may be convex and the corresponding connecting portion edge 2150 would then be concave or the wheel insert edge 2151 may be concave and the corresponding connecting portion edge 2150 would then be convex.

The wheel insert 2166 may be inserted into a front side of the connecting portion of the wheel wherein the rear side of the wheel insert is exposed to view when the wheel is mounted on a vehicle or the wheel insert 2166 may be inserted into a rear side of the connecting portion of the wheel wherein the front side of the wheel insert 2166 is exposed to view when the wheel is mounted on a vehicle. Design indicia is displayed on the side exposed to view.

The fasteners 2110 are inserted into the rear side 2120 of the wheel insert 2166 and extend through the edge of the wheel insert 2166 wherein the detent 2125 extends into slots 2185 in the reciprocating orifices 2180 in the curved edge 2150 of the connecting portion aperture 2170. The fasteners 2110 are inserted and twisted until the detent 2125 engages the reciprocating orifices. The springs 2135 maintain tension on the wheel insert, thus securing the wheel insert 2166 into the connecting portion aperture 2170.

FIG. 22 is a flowchart demonstrating a method of protecting a brake assembly of an embodiment of the present invention 2200. To start 2201 the method, the method includes cleaning each wheel insert edge surface and each connecting portion aperture edge surface 2210. The method continues by applying a sealant to each wheel insert edge surface and each connecting portion aperture edge surface 2220. The method continues by fitting a wheel insert into a connecting portion aperture 2203 such that the wheel insert and a front surface of the connecting portion are aligned parallel at a junction thereof 2240. The method continues fastening the wheel insert to the connecting portion by inserting the fasteners into the apertures in the wheel insert through the wheel insert edge and into reciprocating orifices of the connecting portion 2250. Then the method continues by allowing the sealant to set to ensure secure connection of the wheel insert to the connecting portion of the wheel 2260. The method continues by securing the axle engaging portion of the wheel to an axle on a vehicle. The result of the method is that the brake assembly resides behind the wheel and protected from damage 2280, wherein the method ends 2299.

In an alternate embodiment of the method of connecting the wheel insert into the connecting portion aperture of a wheel, the wheel inserts may be welded to the connection portion aperture of the wheel. A sealant would not be required if the wheel insert is welded into the connecting portion aperture of the wheel.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for filling an aperture in a wheel, the wheel having at least one lug receiving opening and at least one aperture; and
at least one wheel insert insertable into the at least one aperture in the wheel, the method comprising:
securing the at least one wheel insert into the at least one aperture in the wheel.

2. The method of claim 1, wherein securing the at least one wheel insert into the at least one aperture further comprises, inserting the at least one wheel insert into the at least one aperture from the rear side of the wheel.

3. The method of claim 1, wherein securing the at least one wheel insert into the at least one aperture further comprises, inserting the at least one wheel insert into the at least one aperture from the front side of the wheel.

4. The method of claim 1, wherein securing the at least one wheel insert into the at least one aperture further comprises, welding the at least one wheel insert into the at least one aperture in the wheel.

5. The method of claim 1, wherein securing the at least one wheel insert into the at least one aperture further comprises, interlocking an edge of the at least one wheel insert into a reciprocating edge of the at least one aperture of the wheel.

6. A combination wheel and wheel insert comprising;
a wheel, the wheel having at least one lug receiving opening and at least one aperture; and
the at least one wheel insert insertable into the at least one aperture of the wheel.

7. The combination wheel and wheel insert of claim 6, wherein the at least one wheel insert further comprises a side exposed to view, wherein the side has design indicia disposed thereon.

8. The combination wheel and wheel insert of claim 6, wherein the at least one wheel insert further comprises a transparent material fabricated with glitter embedded in the material.

9. The combination wheel and wheel insert of claim 6, wherein the wheel insert further comprises one of a natural and a synthetic material.

10. The combination wheel and wheel insert of claim 6, wherein the at least one wheel insert further comprises a shape selected from an oval, a circle, a square, a rectangle, a triangle, and an irregular shape.

11. The combination wheel and wheel insert of claim 6, wherein the at least one wheel insert further comprises a plurality of teeth disposed along an edge thereof, and the at least one aperture further comprises a plurality of teeth along an interior edge thereof, and wherein the teeth of the at least one wheel insert interlock with the teeth of the edge of the at least one aperture in the wheel.

12. The combination wheel and wheel insert of claim 6, wherein the at least one wheel insert further comprises a flat smooth surface.

13. A wheel insert for insertion into a wheel having at least one aperture and at least one lug receiving opening, the wheel insert comprising;
a front side;
a rear side;
and an edge extending therearound, wherein the wheel insert is insertable into the a least one aperture in the wheel.

14. The wheel insert of claim 13, wherein one of the front or rear side has design indicia disposed thereon.

15. The wheel insert of claim 13, wherein the wheel insert is fabricated from a same material as the wheel.

16. The wheel insert of claim 13, wherein the wheel insert is fabricated from a different material than the wheel.

17. The wheel insert of claim 13, wherein the wheel insert is fabricated from a transparent material.

18. The wheel insert of claim 17, wherein the wheel insert is fabricated from a transparent material and embedded with glitter in the transparent material.

19. The wheel insert of claim 13, wherein the wheel insert is fabricated from an opaque material.

20. The wheel insert of claim 19, wherein the wheel insert is fabricated from an opaque material embedded with glitter in the opaque material.

21. The wheel insert of claim 13, wherein the wheel insert is fabricated from a base metal and is covered with another material.

22. The wheel insert of claim 13, wherein the wheel insert is fabricated from one of a metal, an alloy of metals, and a composite material.

23. The wheel insert of claim 13, wherein the wheel insert further comprises a fastening mechanism for securing the wheel insert in the at least one aperture in the wheel.

24. The wheel insert of claim 13, wherein the wheel insert further comprises at least one edge adapted to cooperatively mate with an interior edge of the aperture in the wheel.

25. The wheel insert of claim 23, wherein the at least one edge adapted to cooperatively mate with an interior edge of the aperture in the wheel has a shape selected from concave, convex, round, oval, triangular, and having a plurality of teeth therearound.
